(19) United States
(12) Patent Application Publication
(10) Pub. No.: US 2008/0023037 A1
(43) Pub. Date: Jan. 31, 2008

(54) Method and apparatus for removing debris from turbine components

(76) Inventors: Lawrence Bernard Kool, Clifton Park, NY (US); Peter Paul Pirolla, Greenville, SC (US); Jane Marie Lipkin, Schenectady, NY (US); Frederick W. Dantzler, Simpsonville, SC (US)

Correspondence Address: CANTOR COLBURN, LLP, 55 GRIFFIN ROAD SOUTH, BLOOMFIELD, CT, 06002, US

(21) Appl. No.: 11/496,994

(22) Filed: Jul. 31, 2006

(51) Int. Cl. B08B 9/00; B08B 3/12

(52) U.S. Cl. 134/22.1; 134/184; 134/166 R

(57) ABSTRACT

A method for removing debris from a turbine component includes routing a cleaning composition comprising fluosilicic acid through an internal passage of the turbine component, without contacting an external surface of the turbine component, to remove the debris.

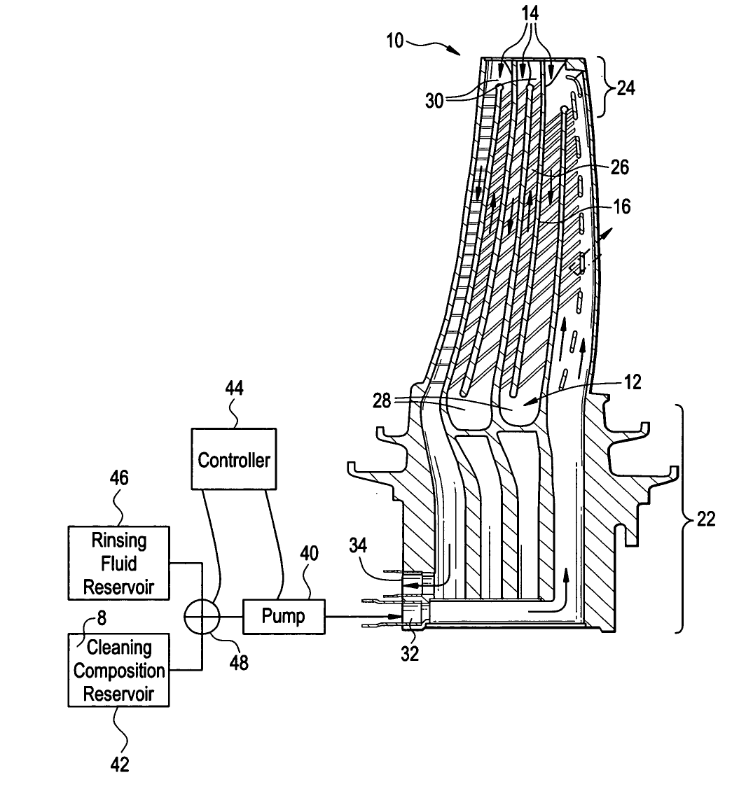

### BACKGROUND OF THE INVENTION

The present disclosure relates to methods and compositions for cleaning articles. More particularly, the present disclosure relates to methods and compositions for removing debris from turbine components.

Generally, in a gas turbine engine, compressed air is mixed with fuel in a combustor and ignited, generating a flow of hot combustion gases through one or more turbine stages that extract energy from the gas, producing output power. Each turbine stage includes a stator nozzle having vanes that direct the combustion gases against a corresponding row of turbine blades or buckets extending radially outward from a supporting rotor disk. The vanes and blades or buckets are subject to substantial heat load, and, because the efficiency of a gas turbine engine is related to gas temperature, the continuous demand for efficiency translates to a demand for airfoils that are capable of withstanding higher temperatures for longer service times.

Gas turbine airfoils on such components as vanes and blades are usually made of superalloys and often employ internal cooling channels to avoid overheating the component to temperatures beyond the capabilities of these materials. The term “superalloy” is usually intended to embrace iron-, cobalt-, or nickel-based alloys, which include one or more other elements including such non-limiting examples as aluminum, tungsten, molybdenum, titanium, and iron. The internal air-cooling of turbine airfoils is often accomplished via a complex cooling scheme in which cooling air flows through channels (“internal channels” or “internal cooling channels”), often serpentine in shape, within the airfoil and is then discharged through a configuration of small cooling holes at the airfoil surface. Convection cooling occurs within the airfoil from heat transfer to the cooling air as it flows through the internal cooling channels.

A considerable amount of cooling air is often required to sufficiently lower the surface temperature of an airfoil. This cooling air generally contains particulate matter, such as dust, sand, mineral deposits, and other foreign matter entrained in the air taken in to cool the engine. The particles can adhere to the walls of the internal cooling channels and accumulate to a point where the cooling airflow through the channel is partially or completely restricted. The resulting restrictions in cooling airflow promote higher component operating temperatures and the accompanying risk of performance problems, including severe damage to the component due to overheating.

Accordingly, the blades or buckets can be cleaned to remove the debris. However, a problem associated with current cleaning methods is that current cleaning methods may not completely remove the debris from the internal passage. Another problem associated with current cleaning methods is that current cleaning methods can use chemicals that can undesirably react with the base metal material of an inner wall of the turbine bucket. Further, costs associated with these cleaning methods include costs associated with loss of operation time and costs associated with labor. For example, during cleaning, an operator stops the operation of the turbine, disassembles the turbine components, cleans the components, and then reassembles the turbine.

Therefore, an improved method for removing debris from the turbine blades or buckets is needed.

### BRIEF DESCRIPTION OF THE INVENTION

A method for removing debris from a turbine component includes routing a cleaning composition comprising fluosilicic acid through an internal passage of the turbine component, without contacting an external surface of the turbine component, to remove the debris.

In another embodiment, the method includes heating a cleaning composition comprising about 60 percent to about 85 percent by volume of an about 23 percent by weight solution of fluosilicic acid in water, about 14 percent to about 30 percent by volume of an about 80 percent by weight solution of phosphoric acid in water, and about 1 percent to about 10 percent by volume of an about 37 percent by weight solution of hydrochloric acid in water; and routing the heated cleaning composition through an internal passage of the turbine component, without contacting an external surface of the turbine component, to remove the debris.

An apparatus for removing debris from a turbine component includes a cleaning composition comprising fluosilicic acid; a reservoir configured to store the cleaning composition; and a pump configured to route the cleaning composition from the reservoir through an internal passage of the turbine component without contacting an external surface of the turbine component via a connector between the pump and the turbine component.

### BRIEF DESCRIPTION OF THE DRAWINGS

Referring now to the FIGURE, which is an exemplary embodiment:

The FIGURE is a schematic illustration of a cross-sectional view of a turbine bucket and an apparatus for removing debris from the turbine bucket in accordance with one embodiment of the present disclosure.

### DETAILED DESCRIPTION OF THE INVENTION

Disclosed herein are methods and apparatuses for cleaning the internal channels or passages of metallic articles. In an exemplary embodiment, the methods, apparatuses, and compositions are used to remove debris from a turbine component such as a bucket, blade, or the like. The term “bucket” and “blade” can be used interchangeably; generally a bucket is a rotating airfoil of a land-based power generation turbine engine, and a blade is a rotating airfoil of an aircraft turbine engine.

Referring now to the FIGURE, wherein a turbine bucket 10 is shown. The bucket 10 includes an inner wall 16. The method generally includes routing a cleaning composition 8 through an internal passage 12 defined by the inner wall 16 of bucket 10, wherein the cleaning composition is effective to remove debris 14 disposed in the internal passage 12. By “remove”, it is meant that the amount or concentration of debris present in the internal passage 12 decreases after the cleaning composition 8 has been routed through the internal passage 12 of the bucket 10. Specifically, decreasing the concentration of the debris can include flushing or rinsing the debris from the internal passage 12, dissolving the debris within the internal passage 12, or the like. In one embodiment, the concentration of the debris in the internal passage 12 is reduced by greater than or equal to about 95 percent based on the total weight of the debris prior to routing the cleaning composition 8 through the internal passage 12. In another embodiment, the concentration of the debris in the internal passage 12 is reduced by greater than or equal to about 99 percent.

As used herein, “debris” can include any undesired material disposed in the internal passage 12. Debris 14 can include material disposed when forming the inner wall 16 (e.g., through casting processes, machining processes, coating or other material deposition processes, and like processes), material disposed when a cooling fluid, other fluids, or other media are routed through internal passage 12 (e.g., during operation of the turbine bucket 10), or reaction products of reactions involving material of the inner wall 16. Debris 14 can comprise various materials including organic compounds (e.g., carbon, soot, hydrocarbons, and the like), as well as inorganic compounds (e.g., metals, metal oxides, and the like).

Inner wall 16 can comprise various materials capable meeting selected functional requirements (e.g., capable of withstanding selected stress levels, selected temperature ranges, and/or an oxidative environment). Inner wall 16 can be formed from the same material as other parts of the turbine bucket or a different material (e.g., the inner wall 16 can comprise a coating). The inner wall can comprise a superalloy coating, a nickel aluminide (NiAl) coating, a chromium-containing coating (e.g., coatings with the general formula MCrAl (X), where M is an element selected from the group consisting of Ni, Co, Fe, and combinations thereof; and X is an element selected from the group consisting of Y, Ta, Si, Hf, Ti, Zr, B, C, and combinations thereof), or the like.

The cleaning composition 8 is provided to remove debris 14 from the internal passage 12, without significantly chemically reacting with the inner wall 16 (i.e., reacting with the internal wall 16 in a manner that measurably effects the structural integrity and/or operational performance of the bucket 10). Specifically, the cleaning composition 8 comprises fluosilicic acid (H₂SiF₆), which can also be referred to in the art as “fluorosilicic acid”, “hydrofluosilicic acid”, “hexafluorosilicic acid”, and “HFS”). The chemical properties of cleaning composition 8 having fluosilicic acid allows the cleaning composition to specifically react with the debris 14 without significantly reacting with the material comprising the inner wall 16.

Cleaning composition 8 may further comprise a mineral acid. For example, hydrochloric acid, phosphoric acid, nitric acid, sulfuric acid, or the like, or a combination comprising at least one of the foregoing mineral acids can be used. The particular mineral acid chosen will depend on the composition of the inner wall 16 of the turbine bucket 10. Specifically, the mineral acid should be chosen such that it does not chemically react with the inner wall 16 of the turbine bucket 10 or the fluosilicic acid and does not adversely affect the debris removal ability of the fluosilicic acid.

In an exemplary embodiment, cleaning composition 8 comprises fluosilicic acid, phosphoric acid, and hydrochloric acid. An exemplary formulation for cleaning composition 8 includes about 60 percent to about 85 percent by volume of an about 23 percent by weight solution of fluosilicic acid in water, about 14 percent to about 30 percent by volume of an about 80 percent by weight solution of phosphoric acid in water, and about 1 percent to about 10 percent by volume of an about 37 percent by weight solution of hydrochloric acid in water. More specifically, cleaning composition 8 includes about 70 percent to about 78 percent by volume of an about 23 percent by weight solution of fluosilicic acid in water, about 20 percent to about 25 percent by volume of an about 80 percent by weight solution of phosphoric acid in water, and about 2 percent to about 8 percent by volume of an about 37 percent by weight solution of hydrochloric acid in water. Even more specifically, cleaning composition 8 includes about 71.25 percent by volume of an about 23 percent by weight solution of fluosilicic acid in water, about 23.75 percent by volume of an about 80 percent by weight solution of phosphoric acid in water, and about 5 percent by volume of an about 37 percent by weight solution of hydrochloric acid in water.

Bucket 10 generally extends radially from a core (not shown) of the turbine engine. Bucket 10 has a base portion 22 disposed proximate the core and a tip portion 24 disposed away from the core. Inner wall 16 defines the internal passage 12 with a serpentine shape having alternating radially extending portions 26 that extend between a lower bend portion 28 comprising 180° bends proximate the base portion 22 and an upper bend 30 comprising 180° bends proximate the tip portion 24. Although debris 14 can be disposed in any location of the internal passage 12, due to the shape of the interior passage 12, debris is specifically susceptible to deposition in the bend portions 28 and 30. In an exemplary embodiment, the internal passage 12 is a closed circuit. During operation of the turbine, fluid can be routed into the internal passage into the inlet section 32 and fluid is routed out of the internal passage through the outlet section 34. Specifically, a pump 40 can pump steam or other cooling fluid into internal passage 12 via a connector between the pump 40 and the inlet section 32 of the bucket 10, and the steam can be forced through the inlet section 32, to extending portions 26, and bend portions 28 and 30, and then to the outlet section 34 (as represented in the FIGURE by arrows illustrating the general flow direction of fluid throughout the internal passage 12). It should be recognized that the method for removing debris disclosed herein could be utilized in turbine components having various other internal passage designs. Since internal passage 12 is a closed circuit, fluid is transferred through the internal passage 12 without contacting an outer surface of the bucket 10.

Cleaning composition 8 can be disposed in a cleaning composition reservoir 42 prior to being routed through the internal passage 12. The cleaning composition reservoir 42 is configured to maintain the cleaning composition at selected conditions (e.g., selected pressure and/or temperature). A heater (e.g., a resistance heating coil), disposed in operative communication with the cleaning composition reservoir 42, can be configured to heat cleaning composition 8 to a specific temperature prior to utilizing cleaning composition 8 in bucket 10. The particular temperature can be selected to provide the cleaning composition with selected properties for removing debris. For example, the heater can heat cleaning composition 8 to a temperature of about 50 degrees Celsius to about 100 degrees Celsius, specifically, about 70 degrees Celsius to about 90 degrees Celsius, and more specifically to a temperature of about 80 degrees Celsius.

In an exemplary embodiment, pump 40 can be utilized to pump the cooling fluid described above, as well as cleaning composition 8 and a rinsing fluid for rinsing the internal passage 12 after removing the debris. Alternatively, a different pump (not shown) can be utilized to pump each of the fluids routed through the internal passage 12. Cleaning composition 8 can be pumped from reservoir 42 and through the internal passage 12. Similar to the cooling fluid described above, since internal passage 12 comprises a closed circuit, cleaning composition 8 can be transferred through the internal passage 12 without contacting an outer surface of bucket 10. By not contacting the cleaning composition 8 with the outer surface of the bucket 10, the method prevents any undesirable interactions between cleaning composition 8 and the outer surface of the bucket 10.

Cleaning composition 8 can be pumped at a selected rate and pressure for a selected time period to remove debris 14 from internal passage 12. For example, cleaning composition 8 can be pumped through an internal passage 12 at a rate of about one liter per minute to about 50 liters per minute, specifically, about four liters per minute to about 25 liters per minute, and more specifically about 12 liters per minute to about 20 liters per minute.

The total time for routing the cleaning composition 8 through the internal passage 12 can be about 10 minutes to about 10 hours. However, the exact time will be dependent on the level of debris 14 and the extent of debris removal desired. For example a measurement, such as by X-ray imaging or other non-destructive evaluation technique (e.g., measuring air flow capability of the internal channels) can be used to determine the point at which the internal passages are satisfactorily clear of debris 14. In an exemplary embodiment an X-ray device (not shown) can be utilized to detect the extent of debris 14 present in the internal passage 12. Specifically, an X-ray image of the internal passage 12 can be generated at a selected time interval or continuously to monitor the extent of debris 14.

After the cleaning step, a rinsing fluid (e.g., water) can be routed through internal passage 12 to remove any cleaning composition 8 residue disposed therein. A valve 48 in operative communication with controller 44 (or alternatively with a second controller) can selectively control fluid communication between a cleaning composition reservoir 46 and the internal passage 12. Pump 40, or another pump can be utilized to pump the rinsing fluid through the internal passage 12. Further, the valve 48 can control fluid communication between the rinsing fluid reservoir 46 and the internal passage 12 as well.

Advantageously, the methods described herein can remove debris from the internal passage of a turbine component without the difficulties associated with the prior art. Specifically, the methods can be used to remove debris from internal passage without adversely affecting the material of an inner wall defining the internal passage. The methods can be used to remove debris at a cost effective rate of speed without exposing external surfaces of the bucket to the cleaning composition. In addition, the methods can be used to remove debris from regions of the inner passage, which are not easily accessible for cleaning. Finally, the methods use a composition with highly available commercial compounds providing cost advantages over other methods.

The written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In addition, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., “up to about 25 weight percent, or, more specifically, about 5 weight percent to about 20 weight percent,” is inclusive of the endpoints and all intermediate values of the ranges of “about 5 weight percent to about 25 weight percent,” etc.).

1. A method for removing debris from a turbine component, the method comprising routing a cleaning composition comprising fluosilicic acid through an internal passage of the turbine component, without contacting an external surface of the turbine component, to remove the debris.

2. The method of claim 1, further comprising heating the cleaning composition.

3. The method of claim 2, wherein heating the cleaning composition comprises heating the cleaning composition to a temperature of about 50 degrees Celsius to about 100 degrees Celsius.

4. The method of claim 1, wherein the cleaning composition further comprises a mineral acid.

5. The method of claim 4, wherein the mineral acid is selected from the group consisting of hydrochloric acid, phosphoric acid, nitric acid, sulfuric acid, and combinations comprising at least one of the foregoing mineral acids.

6. The method of claim 1, wherein the cleaning composition comprises:
about 60 percent to about 85 percent by volume of an about 23 percent by weight solution of fluosilicic acid in water;
about 14 percent to about 30 percent by volume of an about 80 percent by weight solution of phosphoric acid in water; and
about 1 percent to about 10 percent by volume of an about 37 percent by weight solution of hydrochloric acid in water.

7. The method of claim 1, wherein routing the cleaning composition comprises routing the cleaning composition at a rate of about 1 liter per minute to about 50 liters per minute.

8. The method of claim 1, further comprising routing a rinsing fluid through the internal passage of the turbine component.

9. The method of claim 1, wherein an inner wall of the internal passage of the turbine component comprises a superalloy.

10. The method of claim 1, wherein the cleaning composition does not chemically react with an inner wall of the internal passage during the routing.

11. The method of claim 1, further comprising generating an X-ray image of the internal passage of the turbine component to detect an amount of debris in the internal passage of the turbine component.

12. The method of claim 1, further comprising measuring an airflow capability of the internal passage of the turbine component to detect an amount of debris in the internal passage of the turbine component.

13. A method for removing debris from a turbine component, the method comprising:
heating a cleaning composition comprising about 60 percent to about 85 percent by volume of an about 23 percent by weight solution of fluosilicic acid in water, about 14 percent to about 30 percent by volume of an about 80 percent by weight solution of phosphoric acid in water, and about 1 percent to about 10 percent by volume of an about 37 percent by weight solution of hydrochloric acid in water; and
routing the heated cleaning composition through an internal passage of the turbine component, without contacting an external surface of the turbine component, to remove the debris.

14. The method of claim 13, wherein heating the cleaning composition comprises heating the cleaning composition to a temperature of about 50 degrees Celsius to about 100 degrees Celsius.

15. The method of claim 13, further comprising routing a rinsing fluid through the internal passage of the turbine component.

16. The method of claim 13, further comprising detecting an amount of debris in the internal passage of the turbine component by generating an X-ray image of the internal passage of the turbine component, measuring an airflow capability of the internal passage of the turbine component, or a combination thereof.

17. The method of claim 13, wherein routing the cleaning composition comprises routing the cleaning composition at a rate of about 1 liter per minute to about 50 liters per minute.

18. An apparatus for removing debris from a turbine component, the apparatus comprising:
a cleaning composition comprising fluosilicic acid;
a reservoir configured to store the cleaning composition; and
a pump configured to route the cleaning composition from the reservoir through an internal passage of the turbine component without contacting an external surface of the turbine component via a connector between the pump and the turbine component.

19. The apparatus of claim 18, further comprising a heater in operative communication with the cleaning composition reservoir, and configured to heat the cleaning composition.

20. The apparatus of claim 18, further comprising a rinsing fluid reservoir configured to store a rinsing fluid for rinsing the internal passage of the turbine component.
